(19) United States
(12) Patent Application Publication
(10) Pub. No.: US 2022/0327784 A1
(43) Pub. Date: Oct. 13, 2022

(54) IMAGE REPROJECTION METHOD, AND AN IMAGING SYSTEM

(71) Applicant: Varjo Technologies Oy, Helsinki (FI)

(72) Inventors: Mikko Strandborg, Hangonkyla (FI); Ville Miettinen, Helsinki (FI); Petteri Timonen, Helsinki (FI)

(73) Assignee: Varjo Technologies Oy, Helsinki (FI)

(21) Appl. No.: 17/226,145

(22) Filed: Apr. 9, 2021

(51) Int. Cl. G06T 19/00; G06T 7/50; G06T 7/90

(52) U.S. Cl. CPC G06T 19/006; G06T 7/50; G06T 7/90; G06T 2219/008

(57) ABSTRACT

Disocclusion in a VR/AR system may be handled by obtaining depth and color data for the disoccluded area from a 3D model of the imaged environment. The data may be obtained by raytracing and included in the image stream by the reprojecting subsystem.

### TECHNICAL FIELD

The present disclosure relates to a method of reprojecting an image to be displayed on a user display unit, and an imaging system with a reprojecting subsystem.

### BACKGROUND

3D images are often reprojected in head-mounted display units to provide a Virtual Reality or Augmented Reality (VR/AR) experience to a user. Such images include a color map and a depth map as is well known in the art. Generally when reprojecting a 3D image, situations arise when the target camera position can see surfaces that were previously occluded by other geometry in the original camera position, for example if the user, wearing a head-mounted display, moves his head in some way so that the perspective is changed, or if something moves in the imaged environment. This is referred to as disocclusion. In such cases the reprojection process has to guess the color content for such pixels. This process is never quite robust, and often results in non-realistic results.

In the case of a Video See-Through (VST) image feed, reprojection is needed in two cases:
to accommodate for end-to-end latency of the VST feed, namely from the VST camera to the display, during head movement (especially rapid turning of head), caused by the delays in image capturing with a digital camera image, the required image processing steps, communication to a display system and displaying, and
for eye reprojection: The VST cameras are in different physical locations than the eyes, so the images must be reprojected to match the eye positions.

### SUMMARY

It is an object of the present disclosure to provide correct image data to disoccluded areas of an image.

The disclosure relates to a method of reprojecting an image of an environment for display on a user display unit, in an imaging system comprising a 3D reconstruction subsystem arranged to maintain a 3D model of the environment based on a first set of sensor input data related to color and depth of objects in the environment, and a reprojection subsystem arranged to render a reprojection of the image based on a second set of sensor input data to a target position, the method comprising, upon the reprojection subsystem detecting a disocclusion of an area of the image, obtaining by the reprojection subsystem color information and depth information for the disoccluded area from the 3D model, rendering, by the reprojection subsystem, the reprojection of the image using data from the 3D model for the disoccluded area, and rendering the final image to be viewed by a user based on the reprojection of the image.

In this way, image data from the 3D model held by the 3D reconstruction subsystem can be obtained by the reprojection subsystem and used to fill in the parts of the image for which data are missing because they have previously been occluded. The target position is normally defined as the position of the user's eye, meaning that the reprojection ensures that the image is displayed correctly to the user in view of any head movements and also the difference in position between the camera and the user's eye.

The disclosure also relates to an imaging system for displaying an image of an environment on a user display unit, comprising
a 3D reconstruction subsystem arranged to render a 3D model of the environment based on a first set of sensor input data related to color and depth of objects in the environment, and
a reprojection subsystem arranged to render a reprojection of the image based on a second set of sensor input data,
an image composition subsystem arranged to render the image to be displayed based on the reprojection,

wherein the reprojection subsystem is arranged, upon detection of a disocclusion of an area in the image, to obtain color and depth information for the disoccluded area from the 3D model and render the reprojection of the image using data from the 3D model for the disoccluded area.

The image composition subsystem may further be arranged to render the image based on the reprojection and added content, said added content being virtual reality and/or augmented reality content.

### Acronyms and Abbreviations

The following acronyms are used in this document:

AR— Augmented Reality

GPU— Graphics Processing Unit

HMD— Head-mounted Display

LIDAR— Light Detection and Ranging

ToF— Time of Flight

VR— Virtual Reality

VST—Video See-Through

### BRIEF DESCRIPTION OF DRAWINGS

Embodiments of the present disclosure will now be described, by way of example only, with reference to the following diagrams wherein:

FIG. 1 shows schematically a VST imaging system, having the components typically present in such a system, and

FIG. 2 is a flow chart of an embodiment of a method according to the invention.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The disclosure relates to a method of reprojecting an image of an environment for display on a user display unit, in an imaging system comprising a 3D reconstruction subsystem arranged to maintain a 3D model of the environment based on a first set of sensor input data related to color and depth of objects in the environment, and a reprojection subsystem arranged to render a reprojection of the image based on a second set of sensor input data to a target position, the method comprising, upon the reprojection subsystem detecting a disocclusion of an area of the image, obtaining by the reprojection subsystem color information and depth information for the disoccluded area from the 3D model, rendering, by the reprojection subsystem, the reprojection of the image using data from the 3D model for the disoccluded area, and rendering the final image to be viewed by a user based on the reprojection of the image.

In this way, image data from the 3D model held by the 3D reconstruction subsystem can be obtained by the reprojection subsystem and used to fill in the parts of the image for which data are missing because they have previously been occluded. The target position is normally defined as the position of the user's eye, meaning that the reprojection ensures that the image is displayed correctly to the user in view of any head movements and also the difference in position between the camera and the user's eye.

The rendering of the image is typically performed by an image composition subsystem based on the reprojection and added content, said added content being virtual reality and/or augmented reality content, to provide a VR/AR image to the user. The added content may be provided by a VR/AR content module, in ways that are common in the art.

The method may be arranged to be performed only if the disoccluded area has at least a minimum size, that is, that the disoccluded area includes at least a minimum number of pixels. This means that a disoccluded area that is so small as to be negligible may be disregarded. The minimum number of pixels may be one or higher.

The disclosure relates to a method of reprojecting an image of an environment for display on a user display unit, in an imaging system comprising a 3D reconstruction subsystem arranged to maintain a 3D model of the environment based on a first set of sensor input data related to color and depth of objects in the environment, and a reprojection subsystem arranged to render a reprojection of the image based on a second set of sensor input data to a target position, the method comprising, upon the reprojection subsystem detecting a disocclusion of an area of the image, obtaining by the reprojection subsystem color information and depth information for the disoccluded area from the 3D model, rendering, by the reprojection subsystem, the reprojection of the image using data from the 3D model for the disoccluded area, and rendering the final image to be viewed by a user based on the reprojection of the image.

In this way, image data from the 3D model held by the 3D reconstruction subsystem can be obtained by the reprojection subsystem and used to fill in the parts of the image for which data are missing because they have previously been occluded. The target position is normally defined as the position of the user's eye, meaning that the reprojection ensures that the image is displayed correctly to the user in view of any head movements and also the difference in position between the camera and the user's eye.

The rendering of the image is typically performed by an image composition subsystem based on the reprojection and added content, said added content being virtual reality and/or augmented reality content, to provide a VR/AR image to the user. The added content may be provided by a VR/AR content module, in ways that are common in the art.

The method may be arranged to be performed only if the disoccluded area has at least a minimum size, that is, that the disoccluded area includes at least a minimum number of pixels. This means that a disoccluded area that is so small as to be negligible may be disregarded. The minimum number of pixels may be one or higher.

The disclosure also relates to an imaging system for displaying an image of an environment on a user display unit, comprising
a 3D reconstruction subsystem arranged to render a 3D model of the environment based on a first set of sensor input data related to color and depth of objects in the environment, and
a reprojection subsystem arranged to render a reprojection of the image based on a second set of sensor input data,
an image composition subsystem arranged to render the image to be displayed based on the reprojection,

wherein the reprojection subsystem is arranged, upon detection of a disocclusion of an area in the image, to obtain color and depth information for the disoccluded area from the 3D model and render the reprojection of the image using data from the 3D model for the disoccluded area.

The image composition subsystem may further be arranged to render the image based on the reprojection and added content, said added content being virtual reality and/or augmented reality content.

At least the first or the second set of sensor input data may include color data from one or more video cameras, such as VST cameras, and depth data from a LIDAR or ToF sensor. Alternatively, depth data can also be be obtained from a stereo camera. As may be understood, both color data and depth data may be provided from any type of suitable sensors. The sensors may be part of the imaging system or may be external sensors. The system preferably comprises a head-mounted display unit on which the image is rendered but may alternatively comprise another suitable type of display unit instead.

The color information and depth information are preferably obtained by following the trajectory of a ray from the user's position through the 3D model for example through GPU raytracing.

The disclosed system and method are particularly useful for display systems that:
Shows real-world environment (either local surroundings or remote environment) to the user, recorded via video cameras or any other means
builds and maintains a 3D reconstruction of that environment
enable the user to control the view origin and direction via some means known per se, including but not limited to HMD pose tracking, or accelerometer in a tablet/phone
involve a non-zero delay between user control input and the display system being able to show the results of said input, which may indicate a need to reproject to hide lagging

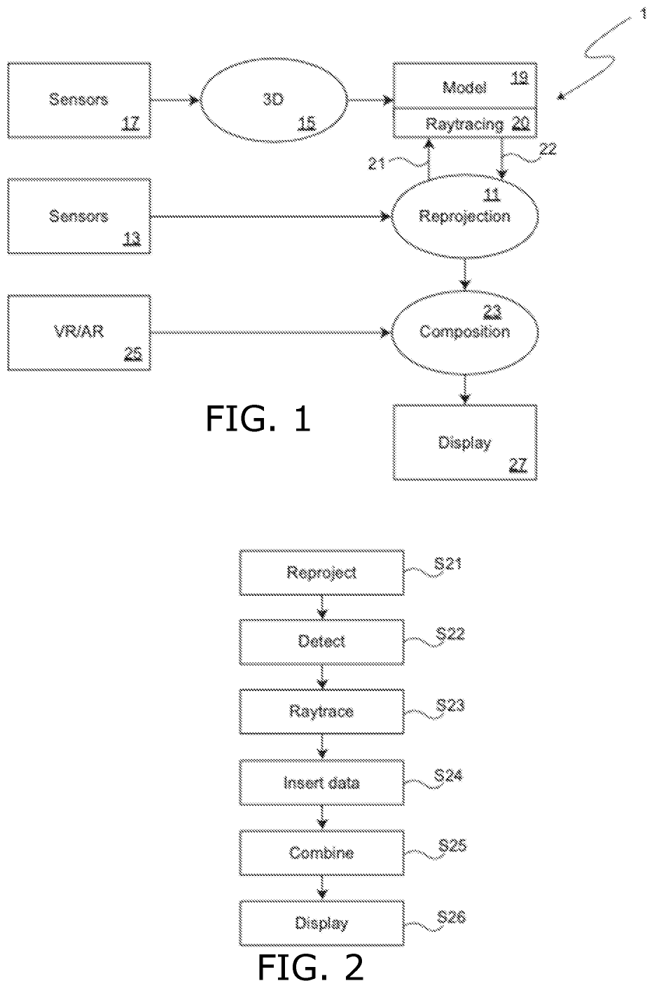

FIG. 1 shows schematically a VST imaging system 1, including the components typically present in such a system.

A reprojection subsystem 11 is arranged to receive an image stream from one or more sensors 13. The sensors typically include cameras, such as VST cameras, and at least one sensor arranged to provide depth data, such as a LI DAR or ToF sensor. The data received from the sensors are used to reproject an image stream including color and depth information from a source position corresponding to the position of the camera, to a target position which is normally the position of the user's eye. Reprojection is used to account for movements of the user's head and also for the difference in positions of the source position and the target position, that is, the camera's position and the location of the user's eye. How to do this is well known in the art.

As is common in the art, the system also comprises a 3D reconstruction subsystem 15 arranged to receive input from various types of sensors 17 and create a 3D reconstruction 19 in the form of an accumulated point cloud or a set of mesh and color information. The 3D reconstruction is kept in a memory unit in, or accessible from, the system. As is known in the art, the sensors 17 providing input to the 3D reconstruction subsystem may include ToF, Lidar, VST cameras, IR cameras and any other suitable source of image and depth information.

Sometimes, an object that has been obscured by another object in the image becomes visible. This is called disocclusion and may happen, for example, if the viewer's head moves, causing the perspective to change, or if an object that is blocking another object moves in the imaged environment. In such cases, the reprojection subsystem 11 may not have sufficient information about the color and/or depth of the disoccluded area to generate a correct image stream regarding this area.

The reprojection subsystem 11 may retrieve color and depth information about the disoccluded area from the 3D reconstruction subsystem 15 and use this color and depth information to fill in the disoccluded area or areas in the reprojected image stream. The color and depth information is preferably obtained by following the trajectory of a ray from the user's position through the 3D model, so that the point of origin of that ray in the 3D reconstruction can be identified and the color and depth information can be obtained from the point of origin. This is illustrated in FIG. 1 by an upwards arrow 21 for the request for information and a downwards arrow 22 for the color and depth information retrieved from the 3D reconstruction. Typically, the trajectory is followed from each disoccluded pixel but the procedure may be performed for any suitable area. This may be done by a function known as GPU raytracing 20 which may be arranged in connection with the 3D reconstruction.

A composition subsystem 23 is arranged in a conventional way to receive the reprojected image stream from the reprojection subsystem and VR/AR content generated in any suitable way by a VR/AR content generating unit 25 and to generate the composite image stream by combining the reprojected image stream and the VR/AR content.

The system comprises a display unit 27, which may be a head-mounted display, on which the composite image stream may be displayed.

The final image stream is projected on a VR/AR display, typically a head-mounted display in a manner known in the art.

FIG. 2 is a flow chart of a method implementing the inventive functions in a VR/AR system such as the one shown in FIG. 1. In a first step S21, a reprojection unit receives input data from one or more cameras, such as VST cameras, and reproject the date to create a reprojected image stream comprising depth and color data. When a disocclusion is detected in step S22, the reprojection unit performs, step S23 a raytracing in the 3D model to identify the disoccluded image area and obtain depth and color information regarding the disoccluded image area. In step S24, the depth and color information is included in the reprojected image stream, which is forwarded to a composition unit arranged to add S25 VR/AR content to the reprojected image stream to create a combined image stream. In step S26, the combined image stream is displayed to a user.

The raytracing function in step S23 may be performed for any disocclusion occurring in the image. Alternatively, it may be determined that some disocclusions can be ignored, for example if they are very small, or if they are located in the periphery of the image. Hence, a minimum number size of the disoccluded area may be defined, for example as a minimum number of pixels, for when step S23 and S24 are to be performed.

Methods of disocclusion detection well known in the field and involve identifying one or more areas which have previously been covered and that are now visible in the image. Disocclusion can be detected by following a ray per pixel from the eye position and checking it against a depth map provided by the reprojection subsystem. If the eye position has changed, there may be rays that do not relate to any pixel in the depth map. In other words, the depth map will have one or more holes, which will indicate a disocclusion.

1. A method of reprojecting an image of an environment for display on a user display unit, in an imaging system comprising
a 3D reconstruction subsystem arranged to maintain a 3D model of the environment based on a first set of sensor input data related to color and depth of objects in the environment,
a reprojection subsystem arranged to render a reprojection of the image based on a second set of sensor input data to a target position,
the method comprising, upon the reprojection subsystem detecting a disocclusion of an area of the image,
obtaining by the reprojection subsystem color information and depth information for the disoccluded area from the 3D model,
rendering, by the reprojection subsystem, the reprojection of the image using data from the 3D model for the disoccluded area,
rendering the final image to be viewed by a user based on the reprojection of the image.

2. A method according to claim 1, wherein the rendering of the image is performed by an image composition subsystem based on the reprojection and added content, said added content being virtual reality and/or augmented reality content.

3. A method according to claim 1, wherein the color information and depth information are obtained by following the trajectory of a ray from the target position through the 3D model.

4. A method according to claim 1, wherein the color information and depth information are obtained through GPU raytracing in the 3D model.

5. A method according to claim 1, wherein the method steps are performed if the disoccluded area includes at least a minimum number of pixels.

6. A method according to claim 1, wherein the at least the first or the second set of sensor input data includes color data from one or more video cameras, such as VST cameras, and depth data from a LIDAR or ToF sensor.

7. An imaging system for displaying an image of an environment on a user display unit, comprising
a 3D reconstruction subsystem arranged to render a 3D model of the environment based on a first set of sensor input data related to color and depth of objects in the environment, and
a reprojection subsystem arranged to render a reprojection of the image to a target position based on a second set of sensor input data,
an image composition subsystem arranged to render the image to be displayed based on the reprojection,
wherein the reprojection subsystem is arranged, upon detection of a disocclusion of an area in the image, to obtain color and depth information for the disoccluded area from the 3D model and render the reprojection of the image using data from the 3D model for the disoccluded area.

8. A system according to claim 7, wherein the image composition subsystem is arranged to render the image based on the reprojection and added content, said added content being virtual reality and/or augmented reality content.

9. A system according to claim 7, wherein the reprojection subsystem is arranged to obtain the color information and depth information by following the trajectory of a ray from the target position through the 3D model.

10. A system according to claim 7, wherein the reprojection subsystem is arranged to obtain the color information and depth information by use of GPU raytracing in the 3D model.

11. A system according to claim 7, comprising at least one video camera such as a VST camera and at least one depth sensor such as a LIDAR or a ToF sensor, arranged to provide input data to the 3D reconstruction subsystem and/or the reprojection subsystem.

12. A system according to claim 7, comprising a head-mounted display unit on which the image is rendered.
